(19) United States
(12) Patent Application Publication
(10) Pub. No.: US 2006/0227956 A1
(43) Pub. Date: Oct. 12, 2006

(54) System and method for providing a missed calls log in a messaging service

(75) Inventor: Larry B. Pearson, San Antonio, TX (US)

Correspondence Address: HANLEY, FLIGHT & ZIMMERMAN, LLC, 20 N. WACKER DRIVE, SUITE 4220, CHICAGO, IL, 60606, US

(73) Assignee: SBC Knowledge Ventures, L.P., Reno, NV (US)

(21) Appl. No.: 11/094,775

(22) Filed: Mar. 30, 2005

(51) Int. Cl. H04M 3/42; H04M 1/64

(52) U.S. Cl. 379/207.15; 379/207.08; 379/88.21; 379/88.12; 379/88.19

(57) ABSTRACT

In one embodiment according to the invention, there is disclosed a method for providing a missed calls log. The method comprises, in a messaging service that communicates with a telephony network, creating a missed calls log of call context information for calls forwarded to the messaging service from the telephony network.

### BACKGROUND OF THE INVENTION

In web-based applications, call logs require infrastructure support from the underlying voice network. For example, in Voice over Internet Protocol (VoIP) networks, call log functionality requires integration with a softswitch. In wireless telephone networks, adding call log functionality requires wireless Intelligent Network development. And in Time Division Multiplexed (TDM) networks, call logs require Advanced Intelligent Network (AIN) development.

Although such call logs that are based on the underlying voice network can provide logging for users' inbound and outbound calls, such functionality can be expensive and complex, particularly for TDM and wireless networks.

Another type of call log is held in a Caller ID device in a customer's home, but such call logs are not integrated with the underlying voice network.

### SUMMARY OF THE INVENTION

There is a need for a simple, inexpensive way to provide identification of missed calls to telephone customers. In one embodiment according to the invention, there is disclosed a method for providing a missed calls log. The method comprises, in a messaging service that communicates with a telephony network, creating a missed calls log of call context information for calls forwarded to the messaging service from the telephony network.

In further, related embodiments, the method may further comprise providing remote access to the missed calls log to a user of the messaging service. The messaging service may comprise a voicemail service or Unified Messaging Service. The telephony network may comprise a Voice over Internet Protocol network, a wireless network, a Time Division Multiplexed network, an Advanced Intelligent network, or any combination thereof. Providing the remote access may comprise providing access to the messaging service over the telephony network, or over a web interface. The missed calls log may comprise calls wherein a message was left on the messaging service, or may comprise calls wherein no message was left on the messaging service. The call context information may comprise a calling number, a redirecting number, and a called number; and may also comprise a privacy indicator. The call context information may be provided to the messaging service over a data link from the telephony network. The data link may be a Primary Rate Interface link or Signaling System 7 link.

In another embodiment according to the invention, there is disclosed a system for providing a missed calls log. The system comprises a messaging service missed calls module for creating, in a messaging service that communicates with a telephony network, a missed calls log of call context information for calls forwarded to the messaging service from the telephony network.

In further, related embodiments the system may comprise a remote access module for providing remote access to the missed calls log to a user of the messaging service. The messaging service may comprise a voicemail service or Unified Messaging Service.

In another embodiment according to the invention, there is disclosed a computer-readable medium carrying one or more sequences of instructions for providing a missed calls log. Execution of the one or more sequences of instructions by one or more processors causes the one or more processors to perform the step of, in a messaging service that communicates with a telephony network, creating a missed calls log of call context information for calls forwarded to the messaging service from the telephony network. Execution of the one or more sequences of instructions may further cause the one or more processors to perform the step of providing remote access to the missed calls log to a user of the messaging service.

In another embodiment according to the invention, there is disclosed a computer program propagated signal product embodied on a propagated signal on a propagation medium, such propagated signal carrying one or more sequences of instructions for providing a missed calls log. Execution of the one or more sequences of instructions by one or more processors causes the one or more processors to perform the step of, in a messaging service that communicates with a telephony network, creating a missed calls log of call context information for calls forwarded to the messaging service from the telephony network. In a further, related embodiment, execution of the one or more sequences of instructions further causes the one or more processors to perform the step of providing remote access to the missed calls log to a user of the messaging service.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a call flow for a voicemail subscriber calling to access messages, when an embodiment according to the invention is installed in the voicemail system;

FIG. 2 is a block diagram of a call flow for a Unified Messaging Service subscriber calling to access messages, when an embodiment according to the invention is installed in the Unified Messaging Service;

FIG. 3 is a block diagram of a call flow for accessing missed calls log information through the telephone, for a voicemail or Unified Messaging Service system in which an embodiment according to the invention is installed;

FIG. 4 shows a graphical user interface, such as a web interface, through which a customer may access a messaging service missed calls log according to an embodiment of the invention;

FIG. 5 is a diagram of the information flow from a telephony network to a messaging service platform in which an embodiment according to the invention is installed; and

FIG. 6 is a block diagram of the architecture of a messaging service 614 in which an embodiment according to the invention may be implemented.

### DETAILED DESCRIPTION OF THE INVENTION

Telephone customers often check their Caller ID device when they return to their homes, generally before checking voicemail. Thus, identifying missed calls is an important aspect of telephone customer behavior. Customers have a desire for a missed calls log; and a low cost missed calls log that can be accessed remotely would be particularly useful.

An embodiment according to the invention therefore provides a missed calls log in a voicemail service or other messaging service, and allows remote access to the missed calls log over a telephone or web interface. In addition to being low cost and allowing remote access, such a missed calls log fills a gap in existing messaging services, in that present voicemail systems only provide customers with calling information for the approximately 20% of callers to a voicemail system who actually leave a voice message.

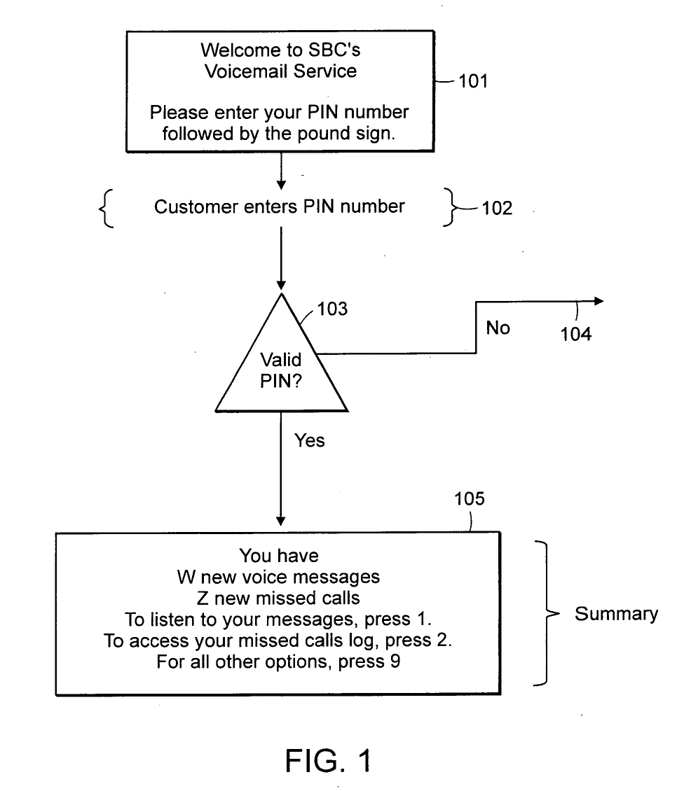

FIG. 1 is a block diagram of a call flow for a voicemail subscriber calling to access messages, when an embodiment according to the invention is installed in the voicemail system. In block 101, the voicemail system welcomes the user and requests their personal identification number, which the user enters at 102. At 103, if the personal identification number is invalid, the system exits 104 (or requests the number again); and if the personal identification number is valid, the system proceeds to block 105. In block 105, the voicemail system informs the user of the number of new voice messages that the user has, along with the number of new missed calls; and gives the user the option of listening to the messages, as well as the option of accessing the missed calls log.

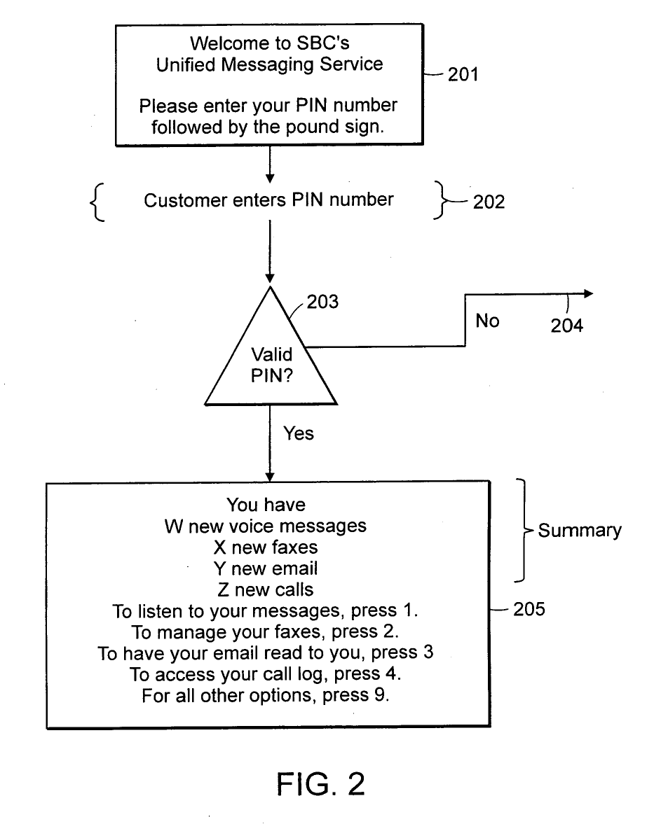

FIG. 2 is a block diagram of a call flow for a Unified Messaging Service (UMS) subscriber calling to access messages, when an embodiment according to the invention is installed in the Unified Messaging Service. In block 201, the UMS system welcomes the user and requests their personal identification number, which the user enters at 202. At 203, if the personal identification number is invalid, the system exits 204 (or requests the number again); and if the personal identification number is valid, the system proceeds to block 205. In block 205, the UMS system informs the user of the number of new voice messages, faxes, and e-mails that the user has, along with the number of new calls; and gives the user the option of accessing the voice messages, faxes, and e-mails, as well as the option of accessing the calls log.

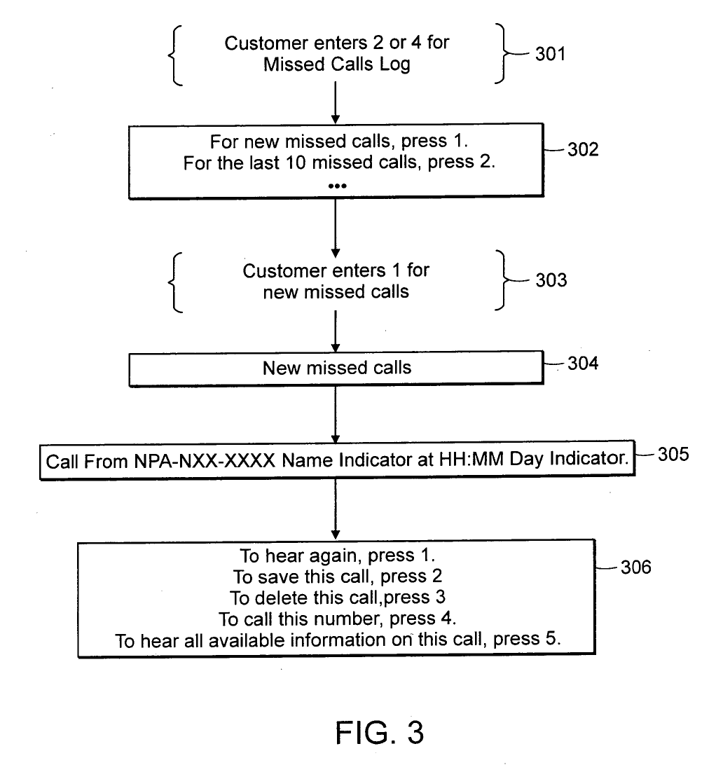

FIG. 3 is a block diagram of a call flow for accessing missed calls log information through the telephone, for a voicemail or Unified Messaging Service system in which an embodiment according to the invention is installed. Having selected the option in FIG. 1 or FIG. 2 of accessing the missed calls log at 301, the customer is given the option at 302 of listening to a list of new missed calls or the last ten missed calls, and enters their selection at 303. For each new call 304 (or similarly for each of the last ten missed calls), the system provides the user, at 305, with an indication of the name of the caller and the time of day at which they called. At 306, the user is given the option of hearing the call information again, saving the call information, deleting the call information, calling the number back, or hearing further available information about the call.

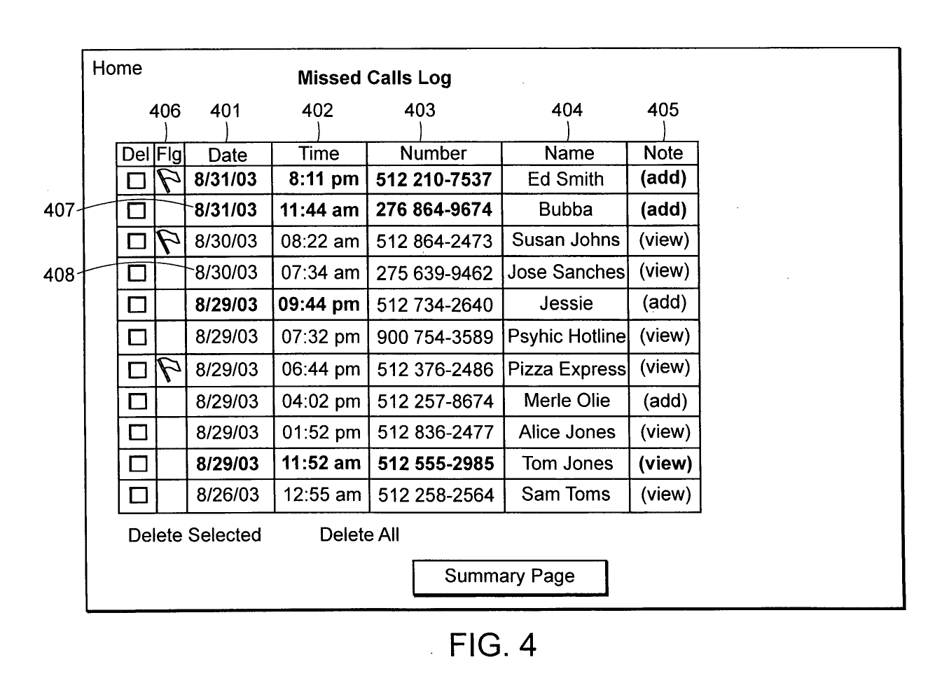

FIG. 4 shows a graphical user interface, such as a web interface, through which a customer may access a messaging service missed calls log according to an embodiment of the invention. Such a graphical user interface may be used for both voicemail and UMS services. The interface shows the date of the missed calls in column 401, the time of the calls in column 402, the caller's number 403, and the caller's name 404. Column 405 lists notes for each call, such as “add” or “view,” and column 406 provides a flag indicator for missed calls of high importance. Missed calls that the user has not yet viewed or returned can be indicated in a bold font 407, while other calls are indicated in normal font 408; and the interface may allow call items to be selected or to be acted upon, in a similar way to that used in other graphical interfaces. It should be appreciated that the details of the telephone and web interfaces of FIGS. 1-4 need not be followed exactly, in embodiments according to the invention.

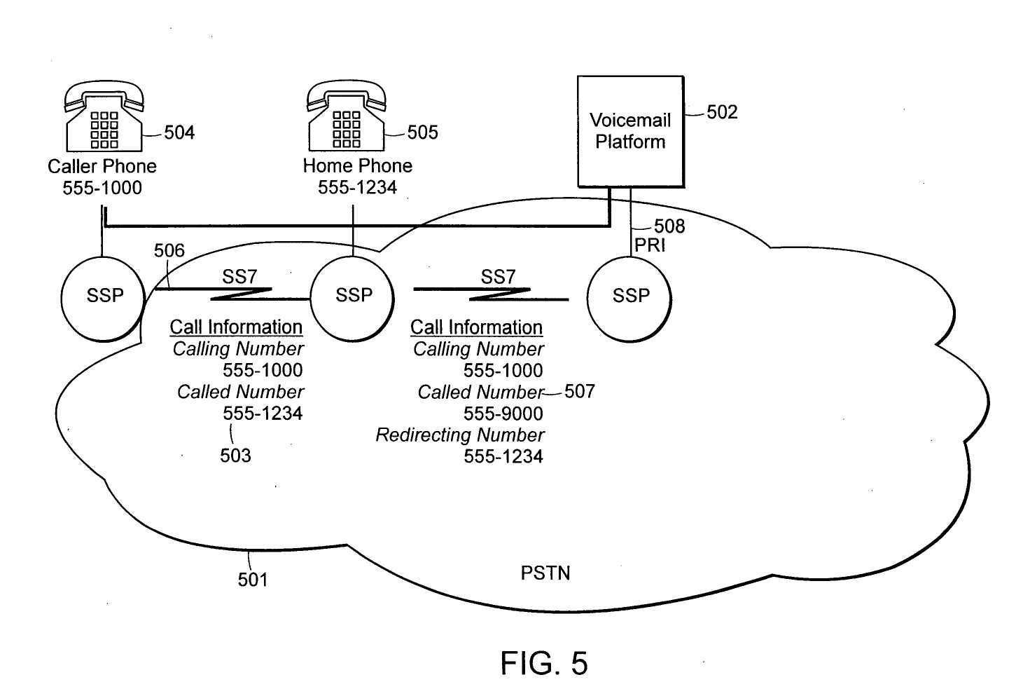

FIG. 5 is a diagram of the information flow from a telephony network 501 to a messaging service platform 502 in which an embodiment according to the invention is installed. A caller's call information 503 is carried from the caller's phone 504 to the subscriber's home phone 505. At this stage 503, the call information 503 includes the calling number and the called number. Such information may be provided, for example, over a Signaling System 7 (SS7) link 506 in a Public Switched Telephone Network (PSTN) 501, although the messaging service may be used with other types of networks having different links. For example, the messaging service may be used with a Voice over Internet Protocol network, a wireless network, a Time Division Multiplexed network, an Advanced Intelligent network, or any combination thereof. If the subscriber's phone 505 is busy or does not answer, the call is forwarded to the messaging service platform 502 (such as a voicemail or UMS platform), via a data link 508, such as a Primary Rate Interface (PRI) link or Signaling System 7 (SS7) link. The call context information 507 forwarded to the messaging service platform 502 includes the calling number, the subscriber's number (or redirecting number), and the platform's telephone number (the called number). This call context information 507 is normally used for inbound call integration (the process of matching inbound calls to voicemail accounts); however, in an embodiment according to the invention, it is used to create a missed calls log in the messaging service. The call context information 507 may include a privacy indicator, such as where the caller's telephone number is marked as PRIVATE or where the calling number is marked as UNKNOWN and is not provided by the underlying telephone network. In order to provide privacy indicators, it may be preferable to present the data to the messaging service platform 502 over PRI or SS7 links.

In an embodiment according to the invention, when calls are presented on the inbound data link 508 of the messaging service platform 502, regardless of whether or not the caller leaves a message, the call is logged in a missed calls log.

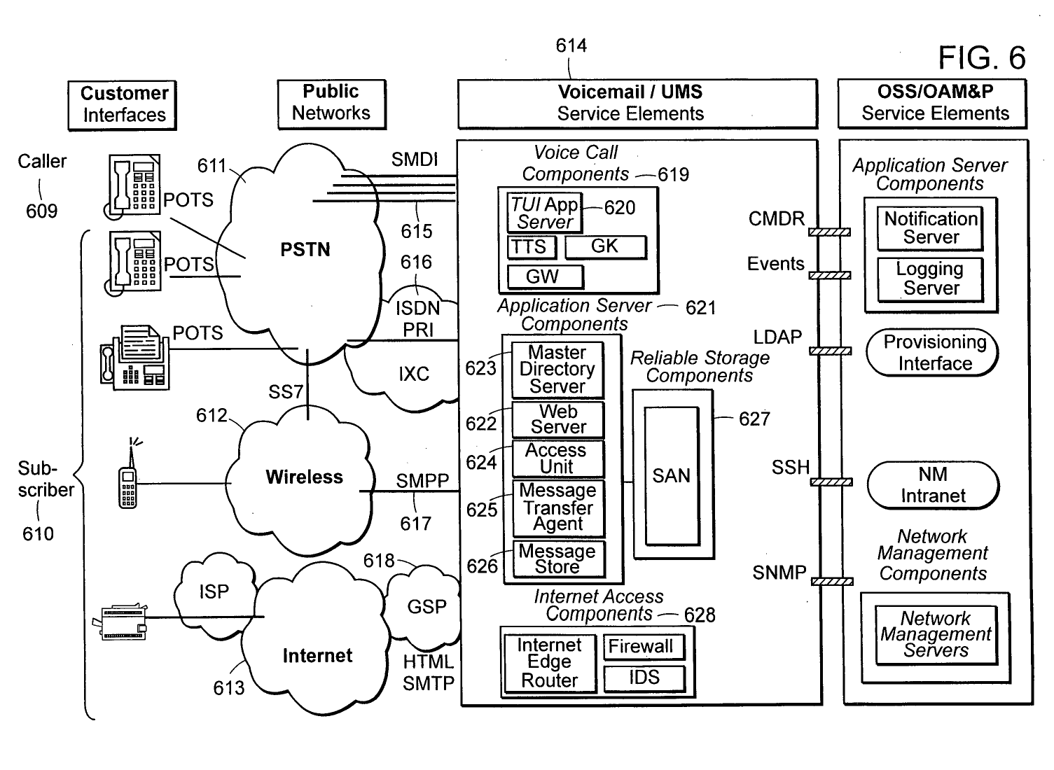

FIG. 6 is a block diagram of the architecture of a messaging service 614 in which an embodiment according to the invention may be implemented. A caller 609 and subscriber 610 are connected to any of several different types of telephone network, such as a Public Switched Telephone Network 611, wireless network 612, or the internet 613. These networks are linked to the messaging service 614 by appropriate data links, such as SMDI links 615, ISDN or PRI links 616, SMPP links 617, or HTML or SMTP links via gateway 618. The messaging service 614 may be, for example, a voicemail service or Unified Messaging Service. The messaging service 614 may include voice call components 619 such as a telephone user interface application server 620; and application server components 621 such as a web server 622, a master directory server 623, an access unit 624, a message transfer agent 625, and a message store 626. The application server components 621 may communicate with a Storage Area Network 627. The messaging service may also include internet access components 628. Among other things, the telephone user interface application server 620 may provide the telephone user interface, such as that presented in FIGS. 1-3, for an embodiment according to the invention. The web server 622 may provide the subscriber web user interface, such as that presented in FIG. 4, for an embodiment according to the invention. The master directory server 623 may store subscriber information such as service class, password, preferences, address book, configuration, phone numbers, and so on; and may be tightly coupled to the web server 622. The access unit 624 may be used by the telephone user interface application server 620 and the web server 622 to retrieve message inventories, messages, greetings, name announcements, and so on. The message transfer agent 625 may be used by the telephone user interface application server 620 and the web server 622 to transfer e-mails. The message store 626 may provide storage for the Unified Messaging Service, and may hold voice, facsimile, or e-mail messages.

In accordance with an embodiment of the invention, a messaging service missed calls module retrieves the call context information 507 (of FIG. 5) from the data links 508 that connect the underlying network 501 to the messaging service 502; collects the call context information into a missed calls log that may stored using storage area network 627; and allows the user to access the missed calls log via a remote access module such as the telephone user interface application server 620 or the web server 622 (of FIG. 6).

It should be appreciated that the methods described herein may be implemented in a variety of ways, including by using one or more processors to execute one or more sequences of instructions, which may be embodied on a computer-readable medium, or as a computer program product embodied on a propagated signal on a propagation medium.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for providing a missed calls log, the method comprising:
in a messaging service that communicates with a telephony network, creating a missed calls log of call context information for calls forwarded to the messaging service from the telephony network.

2. A method according to claim 1, further comprising:
providing remote access to the missed calls log to a user of the messaging service.

3. A method according to claim 2, wherein the messaging service comprises a voicemail service or Unified Messaging Service.

4. A method according to claim 2, wherein the telephony network comprises a Voice over Internet Protocol network, a wireless network, a Time Division Multiplexed network, an Advanced Intelligent network, or any combination thereof.

5. A method according to claim 2, wherein providing the remote access comprises providing access to the messaging service over the telephony network.

6. A method according to claim 2, wherein providing the remote access comprises providing access to the messaging service over a web interface.

7. A method according to claim 2, wherein the missed calls log comprises calls wherein a message was left on the messaging service.

8. A method according to claim 2, wherein the missed calls log comprises calls wherein no message was left on the messaging service.

9. A method according to claim 2, wherein the call context information comprises a calling number, a redirecting number, and a called number.

10. A method according to claim 2, wherein the call context information comprises a privacy indicator.

11. A method according to claim 2, wherein the call context information is provided to the messaging service over a data link from the telephony network.

12. A method according to claim 11, wherein the data link is a Primary Rate Interface link.

13. A method according to claim 11, wherein the data link is a Signaling System 7 link.

14. A system for providing a missed calls log, the system comprising:
a messaging service missed calls module for creating, in a messaging service that communicates with a telephony network, a missed calls log of call context information for calls forwarded to the messaging service from the telephony network.

15. A system according to claim 14, further comprising:
a remote access module for providing remote access to the missed calls log to a user of the messaging service.

16. A system according to claim 15, wherein the messaging service comprises a voicemail service or Unified Messaging Service.

17. A computer-readable medium carrying one or more sequences of
instructions for providing a missed calls log, wherein execution of the one or more sequences of instructions by one or more processors causes the one or more processors to perform the step of:
in a messaging service that communicates with a telephony network, creating a missed calls log of call context information for calls forwarded to the messaging service from the telephony network.

18. A computer-readable medium according to claim 17, wherein execution of the one or more sequences of instructions further causes the one or more processors to perform the step of:
providing remote access to the missed calls log to a user of the messaging service.

19. A computer program propagated signal product embodied on a propagated
signal on a propagation medium, such propagated signal carrying one or more sequences of instructions for providing a missed calls log, wherein execution of the one or more sequences of instructions by one or more processors causes the one or more processors to perform the step of:
in a messaging service that communicates with a telephony network, creating a missed calls log of call context information for calls forwarded to the messaging service from the telephony network.

20. A computer program propagated signal product according to claim 16, wherein execution of the one or more sequences of instructions further causes the one or more processors to perform the step of:
providing remote access to the missed calls log to a user of the messaging service.
